(19) United States
(12) Patent Application Publication
(10) Pub. No.: US 2017/0221402 A1
(43) Pub. Date: Aug. 3, 2017

(54) DISPLAY DEVICE

(71) Applicant: Panasonic Liquid Crystal Display Co., Ltd., Hyogo (JP)

(72) Inventor: Kensuke MURASHIMA, Kanagawa (JP)

(21) Appl. No.: 15/009,835

(22) Filed: Jan. 29, 2016

(51) Int. Cl. G09G 3/18; G09G 3/36

(52) U.S. Cl. CPC G09G 3/18; G09G 3/3685

(57) ABSTRACT

Provided is a liquid crystal display device, including: a plurality of data lines; and a plurality of source drivers configured to output a data signal to each of the plurality of data lines, in which the plurality of source drivers include a plurality of source drivers having different numbers of output channels for outputting the data signal, and in which the number of output channels of each of two first source drivers arranged at both end portions of the plurality of source drivers is set to be smaller than the number of output channels set for each of second source drivers adjacent to the two first source drivers.

### BACKGROUND OF THE INVENTION

1. Field of the Invention

The present application relates to a display device.

2. Description of the Related Art

Hitherto, there is known a liquid crystal display device in which a light source such as an LED is arranged on a side surface side of a display panel and a light guide plate is arranged on a back surface side of the display panel (see, for example, Japanese Patent Application Laid-open No. 2012-155237). In this liquid crystal display device, light emitted from the light source enters the light guide plate, and light that enters the light guide plate is surface-emitted from the light guide plate to irradiate the display panel.

### SUMMARY OF THE INVENTION

In recent years, as the brightness of the liquid crystal display device becomes higher, an amount of heat generated by the light source therein becomes larger. Heat generation by the light source may adversely affect components of the liquid crystal display device. In particular, an amount of heat generated by a source driver becomes larger as the number of output channels thereof becomes larger, and thus a source driver having a large number of output channels is affected by heat generation in accordance with the number of the output channels and heat generation by the light source, and reaches a high temperature. When the temperature varies among a plurality of source drivers, a problem arises that the display quality is reduced.

The present invention has been made in view of the problem described above, and an object of the present invention is to realize a display device capable of improving display quality thereof through reduction of temperature variations among a plurality of source drivers therein.

In order to solve the above-mentioned problem, according to one embodiment of the present application, there is provided a liquid crystal display device, including: a plurality of data lines; and a plurality of source drivers configured to output a data signal to each of the plurality of data lines, in which the plurality of source drivers include a plurality of source drivers having different numbers of output channels for outputting the data signal, and in which the number of output channels of each of two first source drivers arranged at both end portions of the plurality of source drivers is set to be smaller than the number of output channels set for each of second source drivers adjacent to the two first source drivers.

The liquid crystal display device according to the one embodiment of the present application may further include: a display panel; and a backlight device configured to irradiate the display panel with light. In the liquid crystal display device, the backlight device may include a light source arranged along at least one of a left side surface or a right side surface of the display panel, the plurality of source drivers may be arranged along at least one of an upper side surface or a lower side surface of the display panel, and the two first source drivers maybe arranged at locations closer to the light source with respect to the second source drivers.

In the liquid crystal display device according to the one embodiment of the present application, each of the two first source drivers and the second source drivers may include a shift register. The shift register may be configured to perform shift operation in a direction from each of the second source drivers to corresponding one of the two first source drivers.

In the liquid crystal display device according to the one embodiment of the present application, each of the two first source drivers arranged at both the end portions may include a shift register, and a direction of shift operation of the shift register of one of the two first source drivers and a direction of shift operation of the shift register of another of the two first source drivers may be opposite to each other.

In the liquid crystal display device according to the one embodiment of the present application, each of the plurality of source drivers may include a shift register, the plurality of source drivers may be divided into a plurality of groups, each of the plurality of groups may include the first source driver and the second source driver, and in the each of the plurality of groups, the shift register may be configured to perform shift operation in a direction from the second source driver to the first source driver.

In the liquid crystal display device according to the one embodiment of the present application, each of the plurality of source drivers may include a shift register, the plurality of source drivers may be divided into a plurality of groups, and, in each of the plurality of groups, the number of output channels set for corresponding one of the plurality of source drivers, which is arranged on an upstream side in a direction of shift operation of the shift register, may be larger than the number of output channels set for corresponding one of the plurality of source drivers, which is arranged on a downstream side in the direction of the shift operation of the shift register.

In the liquid crystal display device according to the one embodiment of the present application, each of the plurality of source drivers may include a shift register, the plurality of source drivers may be divided into a plurality of groups, and, in each of the plurality of groups, the number of output channels set for corresponding one of the plurality of source drivers, which is arranged closer to a middle of a display panel, may be larger than the number of output channels set for corresponding one of the plurality of source drivers, which is arranged farther from the middle of the display panel.

According to one embodiment of the present application, there is provided a liquid crystal display device, including: a plurality of data lines; and a plurality of source drivers configured to output a data signal to each of the plurality of data lines, in which the plurality of source drivers include a plurality of source drivers having different numbers of output channels for outputting the data signal, and in which the number of output channels of at least two source drivers arranged at both end portions of the plurality of source drivers is set to be smallest of a plurality of numbers of output channels set for the plurality of source drivers, respectively.

### BRIEF DESCRIPTION OF THE DRAWINGS

FIG. 1 is a perspective view for illustrating a schematic structure of a liquid crystal display device according to an embodiment of the present application.

FIG. 2 is a plan view for illustrating a schematic structure of a display panel according to the embodiment.

FIG. 3 is a plan view for illustrating a schematic structure of a display region in the display panel.

FIG. 4 is an illustration of a schematic structure and a graph for showing temperature characteristics of source drivers in a display panel of a comparative example.

FIG. 5 is a block diagram for illustrating operation of the display panel of the comparative example illustrated in FIG. 4.

FIG. 6 is an illustration of a schematic structure and a graph for showing temperature characteristics of source drivers in the display panel according to the embodiment.

FIG. 7 is a block diagram for illustrating operation of the display panel illustrated in FIG. 6.

FIG. 8 is an illustration of a schematic structure and a graph for showing temperature characteristics of source drivers in another display panel according to the embodiment.

FIG. 9 is a block diagram for illustrating operation of the display panel illustrated in FIG. 8.

### DETAILED DESCRIPTION OF THE INVENTION

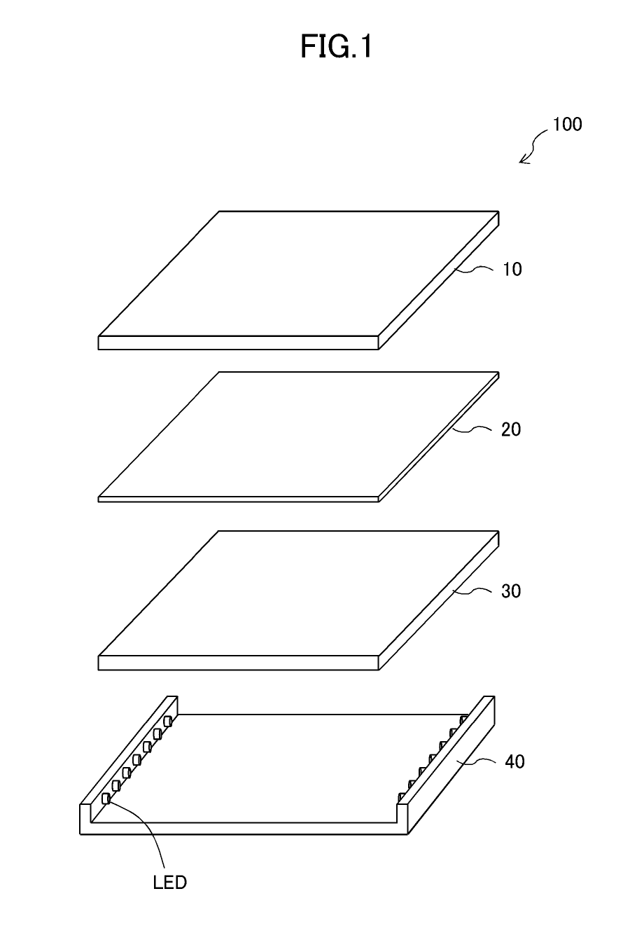

An embodiment of the present application is described in the following with reference to the attached drawings. FIG. 1 is a perspective view for illustrating a schematic structure of a liquid crystal display device according to this embodiment. A liquid crystal display device 100 includes a display panel 10 and a backlight device arranged on a back surface side of the display panel 10 and configured to irradiate the display panel 10 with light. The backlight device includes light emitting diodes (LEDs) serving as a light source configured to emit light, a light guide plate 30 configured to introduce LED light emitted from the LEDs, a diffuser plate 20 configured to diffuse LED light emitted from the light guide plate 30, and a frame 40 configured to receive optical members such as the LEDs, the light guide plate 30, and the diffuser plate 20. The LEDs are arranged on side surfaces of the display panel 10, and thus the liquid crystal display device 100 has a structure of a so-called side light type liquid crystal display device. Note that, the light source is not limited to LEDs.

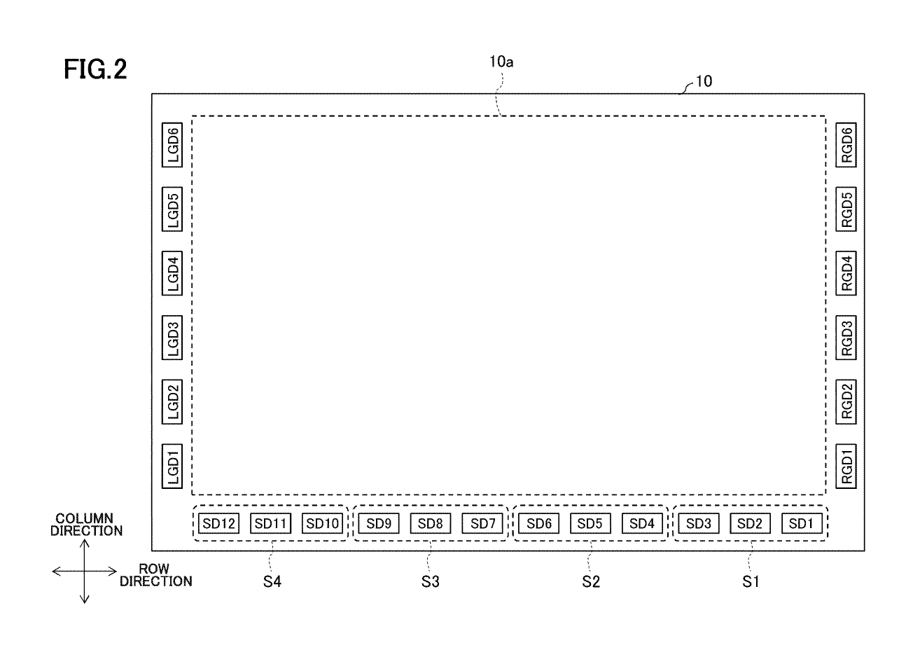

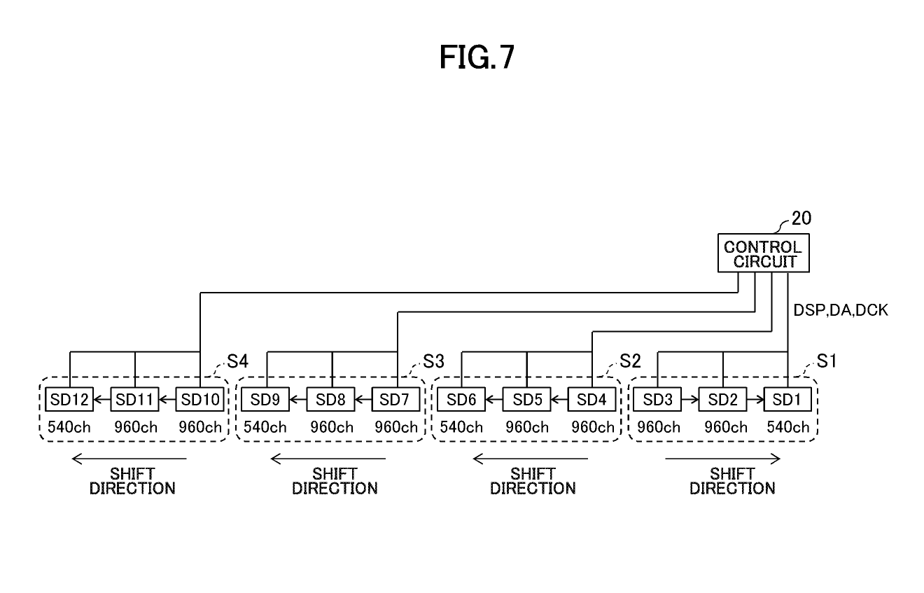

FIG. 2 is a plan view for illustrating a schematic structure of the display panel 10. The display panel 10 includes a plurality of gate drivers GD, a plurality of source drivers SD, and a control circuit 20 (see FIG. 7). The gate drivers GD and the source drivers SD are formed of integrated circuits (ICs). In this embodiment, a chip on glass (COG) type display panel is described as an example, but the present invention is not limited thereto, and, for example, a chip on film (COF) type display panel or a tape carrier package (TCP) type display panel may also be used.

The display panel 10 includes, for example, twelve gate drivers GD. Specifically, the display panel 10 includes six gate drivers RGD1 to RGD6 arranged on a right side of a display region 10a, and six gate drivers LGD1 to LGD6 arranged on a left side of the display region 10a. A predetermined number of output channels is set for each of the gate drivers GD, and a gate signal (scanning signal) in accordance with the number of output channels is output to a corresponding gate line. For example, the number of output channels of the gate drivers RGD1 to RGD5 and LGD1 to LGD5 is set to be 350 ch, while the number of output channels of the gate drivers RGD6 and LGD6 is set to be 328 ch. A scanning direction of the gate lines is not limited. For example, scanning is performed from a top to a bottom of the display panel 10. The gate drivers may be arranged only on one side of the display region 10a.

The display panel 10 further includes, for example, twelve source drivers SD. Specifically, the display panel 10 includes twelve source drivers SD1 to SD12 arranged on a lower side of the display region 10a. The twelve source drivers SD are divided into four groups. A first group S1 includes the source drivers SD1 to SD3, a second group S2 includes the source drivers SD4 to SD6, a third group S3 includes the source drivers SD7 to SD9, and a fourth group S4 includes the source drivers SD10 to SD12. A predetermined number of output channels is set for each of the source drivers SD, and a data signal (source signal) in accordance with the number of output channels is output to a corresponding data line (source line). The source drivers may be arranged on the lower side of the display region 10a, or may be arranged both on an upper side and the lower side of the display region 10a.

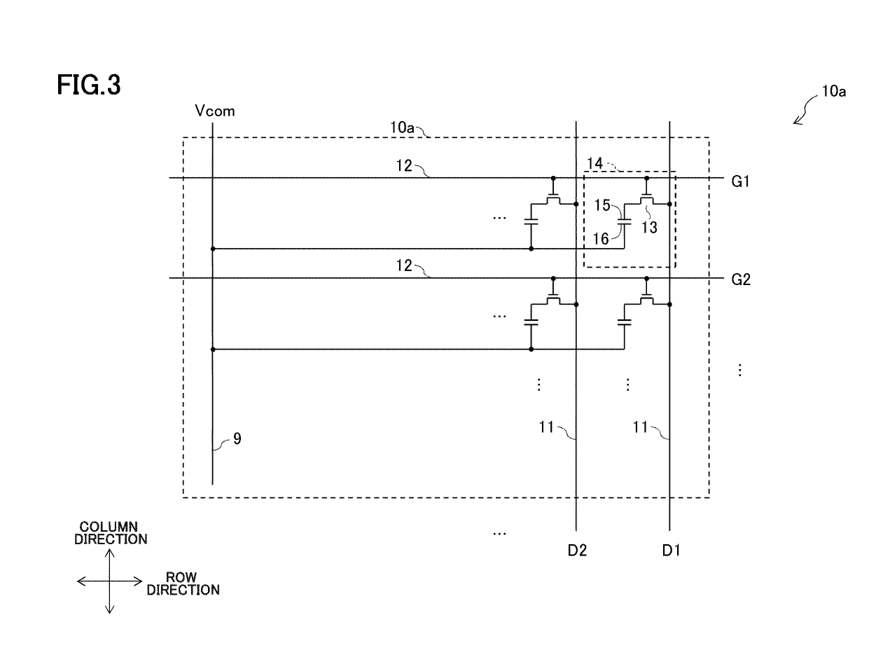

FIG. 3 is a plan view for illustrating a schematic structure of the display region 10a in the display panel 10. The display region 10a includes a plurality of data lines 11 that extend in a column direction and a plurality of gate lines 12 that extend in a row direction. The data lines 11 are electrically connected to the corresponding source drivers SD, respectively, and the gate lines 12 are electrically connected to the corresponding gate drivers GD, respectively, outside the display region 10a. A thin film transistor 13 (TFT) is formed in an intersecting portion of a data line 11 and a gate line 12. A plurality of pixels 14 are arranged in the display panel 10 in matrix (in the row direction and in the column direction) correspondingly to the intersecting portions, respectively, of the data lines 11 and the gate lines 12. Note that, although not shown, the display panel 10 includes a thin film transistor substrate (TFT substrate), a color filter substrate (CF substrate), and a liquid crystal layer sandwiched between the substrates. A plurality of pixel electrodes 15 corresponding to the pixels 14, respectively, and a common electrode 16 common to the pixels 14 are formed on the TFT substrate. The common electrode 16 may be formed on the CF substrate.

A data signal (data voltage) is supplied to each of the data lines 11 from a corresponding source driver SD. A gate signal (gate voltage) is supplied to each of the gate lines 12 from a corresponding gate driver GD. A common voltage Vcom is supplied to the common electrode 16 from a common driver (not shown). When an ON voltage of a gate signal (gate ON voltage) is supplied to a gate line 12, a thin film transistor 13 connected to the gate line 12 is turned on, and the data voltage is supplied to a pixel electrode 15 via a data line 11 connected to the thin film transistor 13. An electric field is generated due to a difference between the data voltage supplied to the pixel electrode 15 and the common voltage Vcom supplied to the common electrode 16. The electric field drives the liquid crystal to control transmittance of LED light emitted from the backlight device, thereby displaying an image. Note that, when color display is performed, the display is realized by supplying a desired data voltage to each of the data lines 11 connected to pixel electrodes 15 of pixels 14 corresponding to red, green, blue, and the like formed with stripe-like color filters.

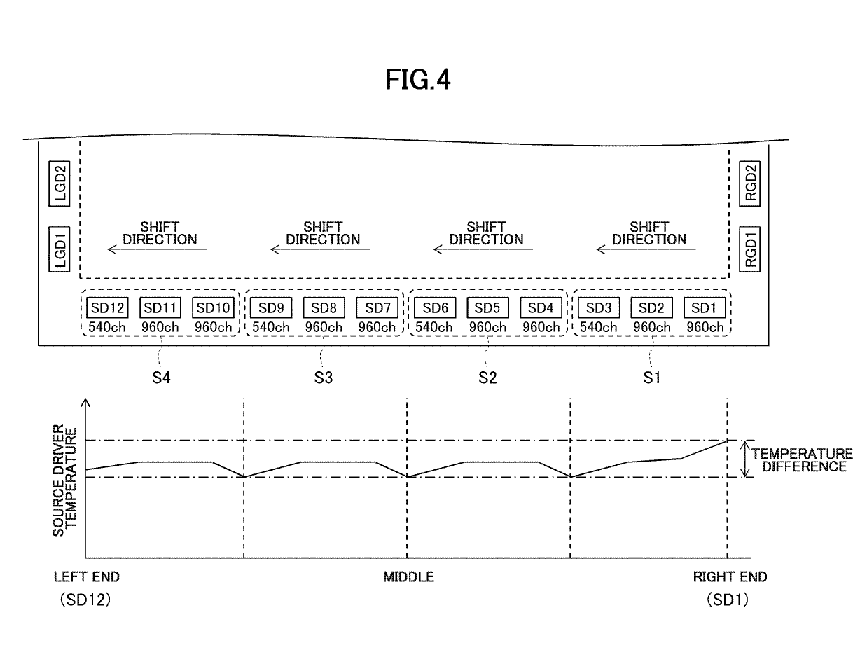

Here, temperature variations among the source drivers SD are reviewed. FIG. 4 is an illustration of a schematic structure and a graph for showing temperature characteristics of the source drivers

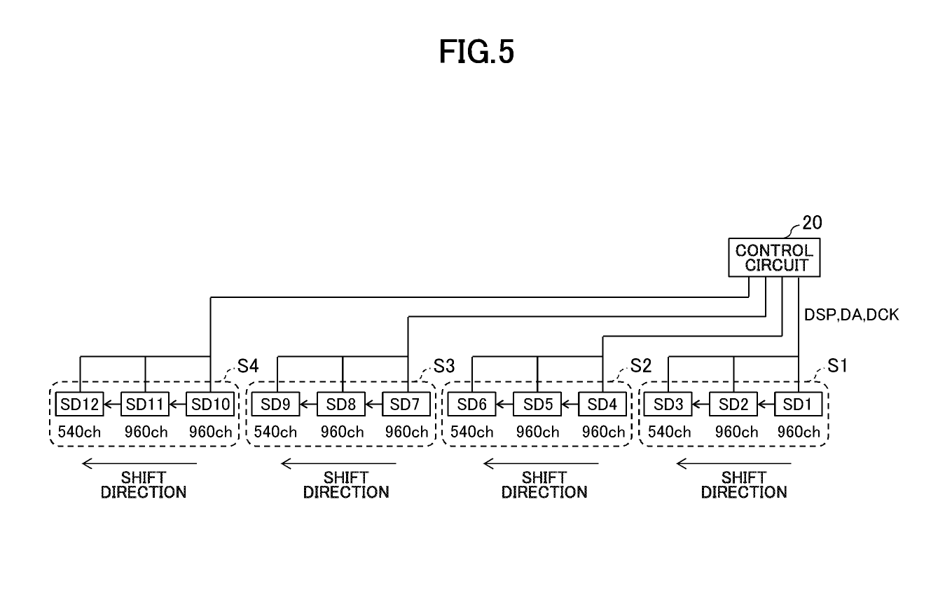

SD in a display panel of a comparative example. FIG. 5 is a block diagram for illustrating operation of the display panel of the comparative example illustrated in FIG. 4.

In the display panel of the comparative example, similarly to the case of the display panel 10 illustrated in FIG. 2, the source drivers SD1 to SD12 are arranged on the lower side of the display region 10a. In the display panel of the comparative example, in each of the first group S1, the second group S2, the third group S3, and the fourth group S4, a plurality of source drivers SD are cascade connected. The number of output channels of the source drivers SD1, SD2, SD4, SD5, SD7, SD8, SD10, and SD11 is set to be 960 ch, while the number of output channels of the source drivers SD3, SD6, SD9, and SD12 is set to be 540 ch. A data start pulse DSP is input from the control circuit 20 to the source drivers SD1, SD4, SD7, and SD10 that are arranged at endmost (rightmost in FIG. 4) portions of the groups, respectively. Further, display data DA in accordance with the set number of output channels and a clock signal DCK are input to each of the source drivers SD1 to SD12. Each of the source drivers SD1 to SD12 includes a shift register, and, while performing shift operation, outputs a data signal in accordance with the set number of output channels to a corresponding data line 11.

For example, when the data start pulse DSP is input to the source driver SD1 in the first group S1, the source drivers SD1, SD2, and SD3 transfer the data start pulse DSP in a direction of this order (shift direction illustrated in FIG. 5) to perform shift operation, and at the same time, based on the display data DA in accordance with the set numbers of output channels and on the clock signal DCK, output data signals in accordance with the set numbers of output channels to corresponding data lines 11. Similarly, when the data start pulse DSP is input to the source driver SD4 in the second group S2, the source drivers SD4, SD5, and SD6 transfer the data start pulse DSP in a direction of this order (shift direction illustrated in FIG. 5) to perform shift operation, and at the same time, based on the display data DA in accordance with the set numbers of output channels and on the clock signal DCK, output data signals in accordance with the set numbers of output channels to corresponding data lines 11. The source drivers in the third group S3 and in the fourth group S4 operate similarly.

In the structure of the display panel of the comparative example illustrated in FIG. 4 and FIG. 5, the source driver SD1 having a large number of output channels for outputting the data signal is arranged at an end portion (right end) of the display panel. As the number of output channels for outputting the data signal of a source driver becomes larger, the amount of heat generated by the source driver becomes larger and the temperature becomes higher. In this case, the light source (LEDs) is arranged on the side surfaces of the display panel, and thus end portions (right end and left end) of the display panel reach a high temperature under the influence of heat generation by the light source. The source drivers arranged at end portions (right end and left end) of the display panel are close to the light source, and thus are more liable to be affected by the heat generation by the light source. Therefore, in the structure of the display panel of the comparative example, as illustrated in FIG. 4, the source driver SD1 reaches a higher temperature than those reached by other source drivers under the influence of the amount of heat generated in accordance with the number of output channels for outputting the data signal and the amount of heat generated by the light source. In other words, a difference between a temperature of the source driver SD6 arranged in the middle of the display panel and the temperature of the source driver SD1 arranged at the end portion of the display panel becomes larger. As described above, the temperatures of the plurality of source drivers vary, and thus the display quality is reduced.

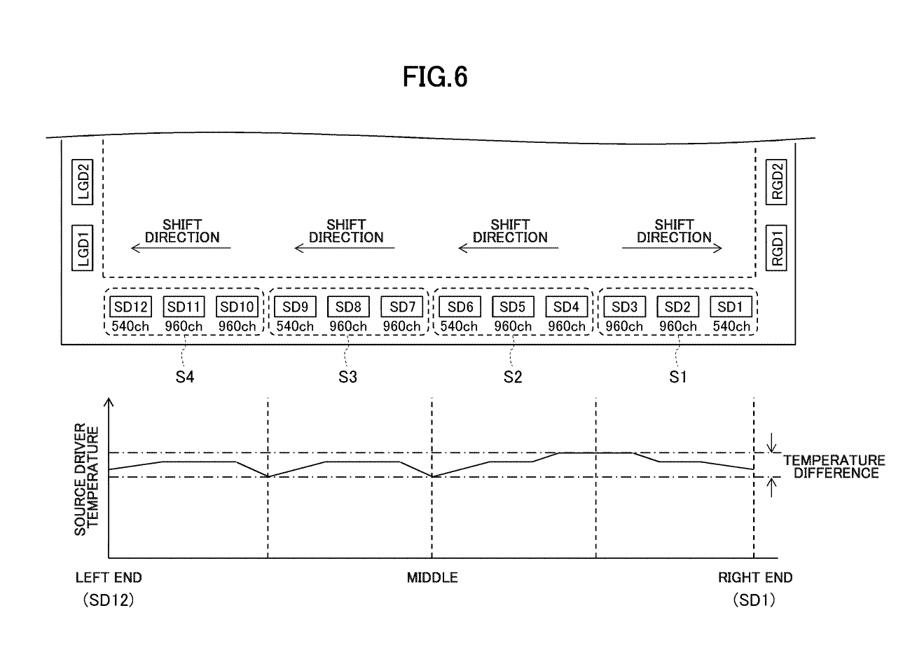

The liquid crystal display device 100 according to this embodiment has a structure for uniformizing the temperature among the plurality of source drivers SD. FIG. 6 is an illustration of a schematic structure and a graph for showing temperature characteristics of the source drivers SD in the display panel 10 according to this embodiment. FIG. 7 is a block diagram for illustrating operation of the display panel 10 illustrated in FIG.

6.

In the display panel 10 according to this embodiment, as illustrated in FIG. 2, the source drivers SD1 to SD12 are arranged on the lower side of the display region 10a. Further, in each of the first group S1, the second group S2, the third group S3, and the fourth group S4, the plurality of source drivers SD are cascade connected. The number of output channels of the source drivers SD2, SD3, SD4, SD5, SD7, SD8, SD10, and SD11 is set to be 960 ch, while the number of output channels of the source drivers SD1, SD6, SD9, and SD12 is set to be 540 ch. Specifically, the number of output channels (540 ch) of the source driver SD1 in the display panel 10 according to this embodiment is set to be smaller than the number of output channels (960 ch) of the source driver SD1 in the display panel of the comparative example. The data start pulse DSP is input from the control circuit 20 to the source drivers SD3, SD4, SD7, and SD10 that are arranged at endmost portions of the groups, respectively. Further, the display data DA in accordance with the set number of output channels and the clock signal DCK are input to each of the source drivers SD1 to SD12. Each of the source drivers SD1 to SD12 includes a shift register, and, while performing shift operation, outputs a data signal in accordance with the set number of output channels to a corresponding data line 11.

For example, when the data start pulse DSP is input to the source driver SD3 in the first group S1, the source drivers SD3, SD2, and SD1 transfer the data start pulse DSP in a direction of this order (shift direction illustrated in FIG. 7) to perform shift operation, and at the same time, based on the display data DA in accordance with the set numbers of output channels and on the clock signal DCK, output data signals in accordance with the set numbers of output channels to corresponding data lines 11. Similarly, when the data start pulse DSP is input to the source driver SD4 in the second group S2, the source drivers SD4, SD5, and SD6 transfer the data start pulse DSP in a direction of this order (shift direction illustrated in FIG. 7) to perform shift operation, and at the same time, based on the display data DA in accordance with the set numbers of output channels and on the clock signal DCK, output data signals in accordance with the set numbers of output channels to corresponding data lines 11. The source drivers SD in the third group S3 and in the fourth group S4 operate similarly to the source drivers SD in the second group S2. Note that, the control circuit 20 and the source drivers SD can be operated in a well-known manner.

In the structure of the display panel 10 illustrated in FIG. 6 and FIG. 7, the number of output channels of the source drivers SD1 and SD12 that are arranged at end portions (right end and left end) of the display panel 10 is set to be small. Therefore, even when the source drivers SD1 and SD12 are affected by the heat generation by the light source, the source drivers SD1 and SD12 reach a temperature that is lower than that reached by the source driver SD1 of the comparative example (see FIG. 4). Therefore, compared with the display panel of the comparative example illustrated in FIG. 4, the display panel 10 can reduce temperature variations (temperature difference) among the plurality of source drivers SD1 to SD12, and thus the display quality thereof can be improved.

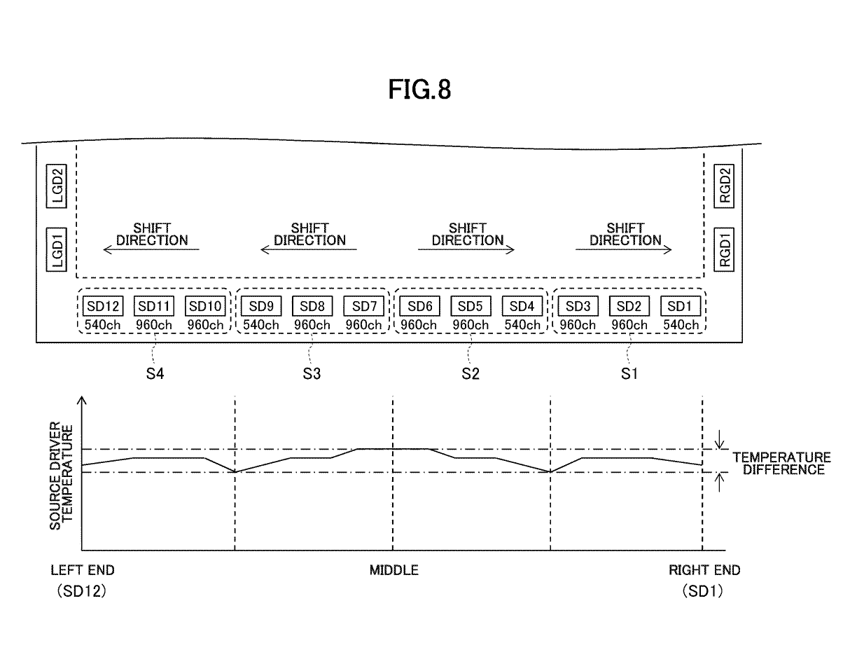

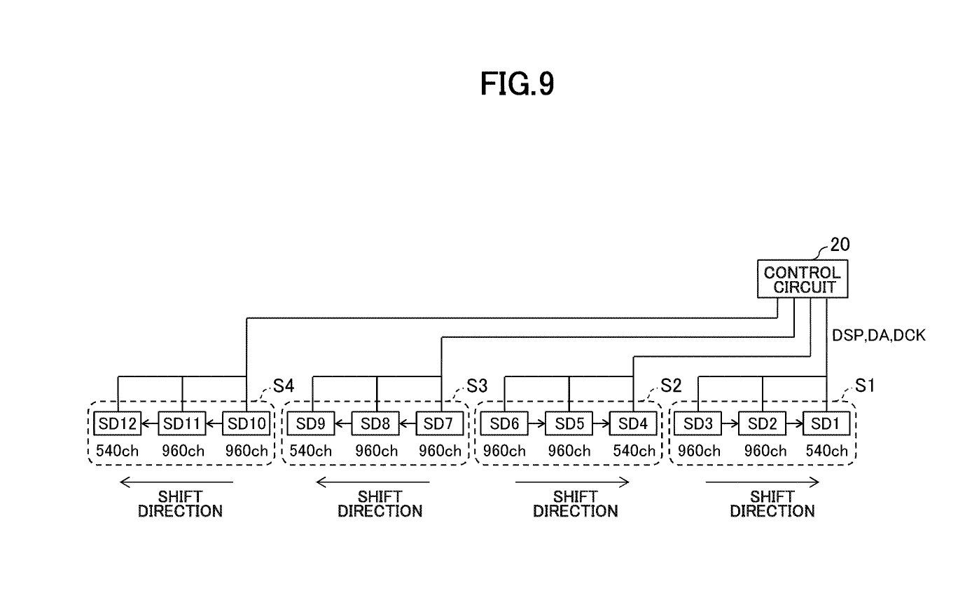

The structure of the display device according to the present invention is not limited to the one illustrated in FIG. 6 and FIG. 7. FIG. 8 is an illustration of a schematic structure and a graph for showing temperature characteristics of source drivers SD in another display panel 10 according to the embodiment. FIG. 9 is a block diagram for illustrating operation of the display panel 10 illustrated in FIG. 8.

In the display panel 10 illustrated in FIG. 8, the number of output channels of the source drivers SD2, SD3, SD5, SD6, SD7, SD8, SD10, and SD11 is set to be 960 ch, while the number of output channels of the source drivers SD1, SD4, SD9, and SD12 is set to be 540 ch. The data start pulse DSP is input from the control circuit 20 to the source drivers SD3, SD6, SD7, and SD10 that are arranged at endmost portions of the groups, respectively. Further, the display data DA in accordance with the set number of output channels and the clock signal DCK are input to each of the source drivers SD1 to SD12. Each of the source drivers SD1 to SD12 includes a shift register, and, while performing shift operation, outputs a data signal in accordance with the set number of output channels to a corresponding data line 11.

For example, when the data start pulse DSP is input to the source driver SD3 in the first group S1, the source drivers SD3, SD2, and SD1 transfer the data start pulse DSP in a direction of this order (shift direction illustrated in FIG. 9) to perform shift operation, and at the same time, based on the display data DA in accordance with the set numbers of output channels and on the clock signal DCK, output data signals in accordance with the set numbers of output channels to corresponding data lines 11. Similarly, when the data start pulse DSP is input to the source driver SD6 in the second group S2, the source drivers SD6, SD5, and SD4 transfer the data start pulse DSP in a direction of this order (shift direction illustrated in FIG. 9) to perform shift operation, and at the same time, based on the display data DA in accordance with the set numbers of output channels and on the clock signal DCK, output data signals in accordance with the set numbers of output channels to corresponding data lines 11.

Further, when the data start pulse DSP is input to the source driver SD7 in the third group S3, the source drivers SD7, SD8, and SD9 transfer the data start pulse DSP in a direction of this order (shift direction illustrated in FIG. 9) to perform shift operation, and at the same time, based on the display data DA in accordance with the set numbers of output channels and on the clock signal DCK, output data signals in accordance with the set numbers of output channels to corresponding data lines 11. Similarly, when the data start pulse DSP is input to the source driver SD10 in the fourth group S4, the source drivers SD10, SD11, and SD12 transfer the data start pulse DSP in a direction of this order (shift direction illustrated in FIG. 9) to perform shift operation, and at the same time, based on the display data DA in accordance with the set numbers of output channels and on the clock signal DCK, output data signals in accordance with the set numbers of output channels to corresponding data lines 11.

In the structure of the display panel 10 illustrated in FIG. 8 and FIG. 9, in the respective groups, the number of output channels of the source drivers SD1, SD4, SD9, and SD12 that are arranged at end portions (right end and left end) of the display panel 10 is set to be small. Further, the groups arranged on the right side from the middle of the display panel 10 (first group S1 and second group S2) perform shift operation rightward, while the groups arranged on the left side from the middle of the display panel 10 (third group S3 and fourth group S4) perform shift operation leftward. Also in the above-mentioned structure, compared with the comparative example illustrated in FIG. 4, temperature variations (temperature difference) among the plurality of source drivers SD1 to SD12 can be reduced, and thus the display quality can be improved.

In each of the structures described above, the number of output channels may be set to be different among the plurality of source drivers SD included in each of the groups. For example, in the display panel 10 illustrated in FIG. 6, with regard to the first group S1, the number of output channels of the source driver SD1 may be set to be 400 ch, the number of output channels of the source driver SD2 may be set to be 960 ch, and the number of output channels of the source driver SD3 may be set to be 1,080 ch. In other words, among a plurality of source drivers SD included in one group, the numbers of output channels of the plurality of source drivers SD may be set to reduce in the shift direction (from an upstream side to a downstream side).

As described above, in the liquid crystal display device 100 according to this embodiment, the number of output channels (540 ch) of each of two source drivers SD arranged at both end portions of the plurality of source drivers SD (for example, source drivers SD1 and SD12 in FIG. 6) is set to be smaller than the number of output channels (960 ch) set for each of source drivers SD (source drivers SD2 and SD11) adjacent to those source drivers SD (source drivers SD1 and SD12). Further, the number of output channels of at least the two source drivers SD arranged at both the end portions of the plurality of source drivers SD is set to be the smallest (for example, 540 ch in FIG. 6) of a plurality of numbers of output channels set for the plurality of source drivers SD, respectively. Note that, the liquid crystal display device 100 may have a structure in which the numbers of output channels of the source drivers SD are switched or a structure in which the shift directions of the shift registers are switched based on a control signal that is output from the control circuit 20.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device, comprising:
a plurality of data lines; and
a plurality of source drivers configured to output a data signal to each of the plurality of data lines,
wherein the plurality of source drivers comprise a plurality of source drivers having different numbers of output channels for outputting the data signal, and
wherein the number of output channels of each of two first source drivers arranged at both end portions of the plurality of source drivers is set to be smaller than the number of output channels set for each of second source drivers adjacent to the two first source drivers.

2. The display device according to claim 1, further comprising:
a display panel; and
a backlight device configured to irradiate the display panel with light,
wherein the backlight device comprises a light source arranged along at least one of a left side surface or a right side surface of the display panel,
wherein the plurality of source drivers are arranged along at least one of an upper side surface or a lower side surface of the display panel, and
wherein the two first source drivers are arranged at locations closer to the light source with respect to the second source drivers.

3. The display device according to claim 1,
wherein each of the two first source drivers and the second source drivers comprises a shift register, and
wherein the shift register is configured to perform shift operation in a direction from each of the second source drivers to corresponding one of the two first source drivers.

4. The display device according to claim 1,
wherein each of the two first source drivers arranged at both the end portions comprises a shift register, and
wherein a direction of shift operation of the shift register of one of the two first source drivers and a direction of shift operation of the shift register of another of the two first source drivers are opposite to each other.

5. The display device according to claim 1,
wherein each of the plurality of source drivers comprises a shift register,
wherein the plurality of source drivers are divided into a plurality of groups,
wherein each of the plurality of groups comprises the first source driver and the second source driver, and
wherein, in the each of the plurality of groups, the shift register is configured to perform shift operation in a direction from the second source driver to the first source driver.

6. The display device according to claim 1,
wherein each of the plurality of source drivers comprises a shift register,
wherein the plurality of source drivers are divided into a plurality of groups, and
wherein, in each of the plurality of groups, the number of output channels set for corresponding one of the plurality of source drivers, which is arranged on an upstream side in a direction of shift operation of the shift register, is larger than the number of output channels set for corresponding one of the plurality of source drivers, which is arranged on a downstream side in the direction of the shift operation of the shift register.

7. The display device according to claim 1,
wherein each of the plurality of source drivers comprises a shift register,
wherein the plurality of source drivers are divided into a plurality of groups, and
wherein, in each of the plurality of groups, the number of output channels set for corresponding one of the plurality of source drivers, which is arranged closer to a middle of a display panel, is larger than the number of output channels set for corresponding one of the plurality of source drivers, which is arranged farther from the middle of the display panel.

8. A display device, comprising:
a plurality of data lines; and
a plurality of source drivers configured to output a data signal to each of the plurality of data lines,
wherein the plurality of source drivers comprise a plurality of source drivers having different numbers of output channels for outputting the data signal, and
wherein the number of output channels of at least two source drivers arranged at both end portions of the plurality of source drivers is set to be smallest of a plurality of numbers of output channels set for the plurality of source drivers, respectively.
